(19) United States
(12) Patent Application Publication
(10) Pub. No.: US 2017/0245135 A1
(43) Pub. Date: Aug. 24, 2017

(54) APPARATUS AND METHOD FOR PROVIDING DATA SERVICE IN ELECTRONIC DEVICE

(71) Applicant: Samsung Electronics Co., Ltd., Suwon-si (KR)

(72) Inventors: Kum-Rye PARK, Suwon-si (KR); Junkeun YOON, Suwon-si (KR); Yongchul LEE, Yongin-si (KR); Hongju PARK, Seongnam-si (KR)

(21) Appl. No.: 15/435,920

(22) Filed: Feb. 17, 2017

(30) Foreign Application Priority Data
Feb. 18, 2016 (KR) 10-2016-0019133

(51) Int. Cl. H04W 8/06; H04W 60/04

(52) U.S. Cl. CPC H04W 8/06; H04W 60/04

(57) ABSTRACT

An apparatus and a method for a data service in an electronic device are provided. The electronic device includes a communication circuit, a memory, a display, a subscriber identification module, and a processor, wherein the processor may be configured to register in an external electronic device through a network having a first public land mobile network (PLMN) by using the communication circuit, to acquire a user-controlled PLMN list related to roaming from the subscriber identification module, and to control the display to display a message asking whether to use a data service when the first PLMN is not included in the user-controlled PLMN list.

### CROSS-REFERENCE TO RELATED APPLICATION(S)

This application claims the benefit under 35 U.S.C. §119(a) of a Korean patent application filed on Feb. 18, 2016 in the Korean Intellectual Property Office and assigned Serial number 10-2016-0019133, the entire disclosure of which is hereby incorporated by reference.

### TECHNICAL FIELD

The present disclosure relates to a method of providing a data service. More particularly, the present disclosure relates to a method and an apparatus for providing a data service through public land mobile network (PLMN).

### BACKGROUND

According to an overseas roaming service, a domestic mobile communication network subscriber may use and access a domestic communication network through his/her own electronic device (for example, a mobile phone) even in a foreign country and use various mobile communication services.

The mobile communication network subscriber may receive not only a voice service but also a data service such as a multimedia data download/upload service or a wireless Internet service through the electronic device.

The above information is presented as background information only to assist with an understanding of the present disclosure. No determination has been made, and no assertion is made, as to whether any of the above might be applicable as prior art with regard to the present disclosure.

### SUMMARY

When a network selection mode is set as automatic, an electronic device may receive a voice/data service without any separate setting whenever the electronic device arrives at a foreign country. When the electronic device escapes from an area of a network in which a roaming contract has been made and is automatically connected to a network in which the roaming contract has not been made, a user cannot recognize a change of the network, so that excessive data fees may be charged.

Aspects of the present disclosure are to address at least the above-mentioned problems and/or disadvantages and to provide at least the advantages described below. Accordingly, an aspect of the present disclosure is to provide an apparatus and method for informing the user of the change of the network for user's convenience when the network is changed.

Another aspect of the present disclosure is to provide an apparatus and method for automatically registering the electronic device in another network for user's convenience even though the electronic device escapes from the area of the network in which the roaming contract has been made.

In accordance with an aspect of the present disclosure, an electronic device is provided. The electronic device includes a communication circuit, a memory, a display, a subscriber identification module, and a processor, wherein the processor is configured to register in an external electronic device through a network having a first public land mobile network (PLMN) by using the communication circuit, to acquire a user-controlled PLMN list related to roaming from the subscriber identification module, and to control the display to display a message asking whether to use a data service when the first PLMN is not included in the user-controlled PLMN list.

In accordance with another aspect of the present disclosure, a method of operating an electronic device is provided. The method includes registering in an external electronic device through a network having a first PLMN, acquiring a user-controlled PLMN list related to roaming from a subscriber identification module, and when the first PLMN is not included in the user-controlled PLMN list, displaying a message asking whether to use a data service.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a network environment according to an embodiment of the present disclosure;

FIG. 2 is a block diagram illustrating an electronic device according to an embodiment of the present disclosure;

FIG. 3 is a block diagram illustrating a server according to an embodiment of the present disclosure;

FIG. 4 illustrates that a data service query message is displayed according to an embodiment of the present disclosure;

FIG. 5 illustrates that a data service is provided according to an embodiment of the present disclosure;

FIG. 6 illustrates that a data service is provided according to an embodiment of the present disclosure;

FIG. 7 is a flowchart illustrating an operation of providing a data service according to various embodiments of the present disclosure;

FIG. 8 is a flowchart illustrating an operation of updating a user-controlled public land mobile network (PLMN) list according to an embodiment of the present disclosure;

FIG. 9 is a flowchart illustrating an operation of updating a user-controlled PLMN list according to an embodiment of the present disclosure; and

FIG. 10 is a flowchart illustrating an operation of updating a user-controlled PLMN list according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the expression “have”, “may have”, “include”, or “may include” refers to the existence of a corresponding feature (e.g., numeral, function, operation, or constituent element such as component), and does not exclude one or more additional features.

In the present disclosure, the expression “A or B”, “at least one of A or/and B”, or “one or more of A or/and B” may include all possible combinations of the items listed. For example, the expression “A or B”, “at least one of A and B”, or “at least one of A or B” refers to all of (1) including at least one A, (2) including at least one B, or (3) including all of at least one A and at least one B.

The expression “a first”, “a second”, “the first”, or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a digital video disc (DVD) player, an audio, a refrigerator, an air conditioner, a vacuum cleaner, an oven, a microwave oven, a washing machine, an air cleaner, a set-top box, a home automation control panel, a security control panel, a television (TV) box (e.g., Samsung HomeSync™, Apple TV™, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). In various embodiments, the electronic device may be a combination of one or more of the aforementioned various devices. According to some embodiments, the electronic device may also be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. In the present disclosure, the term “user” may indicate a person using an electronic device or a device (e.g., an artificial intelligence electronic device) using an electronic device.

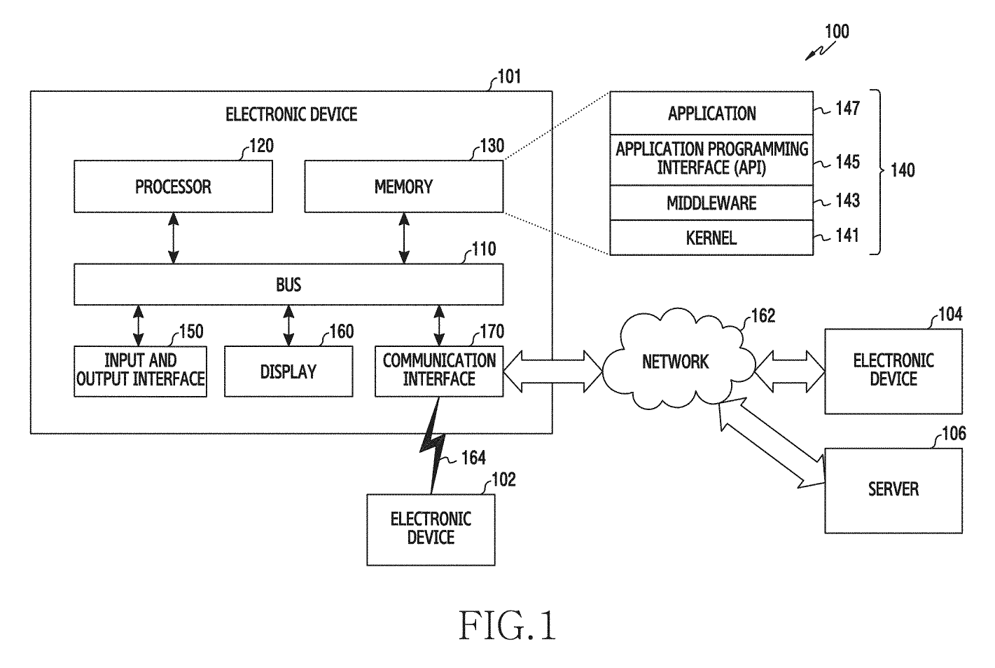

FIG. 1 is a diagram illustrating a network environment including an electronic device according to an embodiment of the present disclosure.

Referring to FIG. 1, an electronic device 101 within a network environment 100, according to various embodiments. The electronic device 101 may include a bus 110, a processor 120, a memory 130, an input/output interface 150, a display 160, and a communication interface 170. According to an embodiment of the present disclosure, the electronic device 101 may omit at least one of the above components or may further include other components.

The bus 110 may include, for example, a circuit which interconnects the components 120 to 170 and delivers a communication (e.g., a control message or data) between the components 120 to 170.

The processor 120 may include one or more of a CPU, an AP, or a communication processor (CP). The processor 120 may perform operations or data processing with respect to control or communication of at least one other element of the electronic device 101. According to an embodiment of the present disclosure, the processor 120 may perform an operation to receive first proximity service data and receive second proximity service data included in the first proximity service data using guide information which is used for receiving the second proximity service data. In addition, the processor 120 may control transmission of the first proximity service data including guide information which is used for receiving the second proximity service data.

The memory 130 may include at least one of a volatile memory or a non-volatile memory. For example, the memory 130 may store commands or data related to at least one other element of the electronic device 101. According to an embodiment, the memory 130 may store at least one of software or programs 140. As illustrated in FIG. 1, the at least one of software or programs 140 may include at least one or more of a kernel 141, middleware 143, an application programming interface (API) 145, or an application program (or an application) 147, etc. At least part of the kernel 141, the middleware 143, or the API 145 may be referred to as an operating system (OS).

The kernel 141 may control or manage system resources (e.g., the bus 110, the processor 120, the memory 130, or the like) used for performing operations or functions implemented by the other programs (e.g., the middleware 143, the API 145, or the application program 147). Additionally, the kernel 141 may provide an interface for allowing the middleware 143, the API 145, or the application program 147 to access an individual element of the electronic device 101 and to control or manage the system resources.

The middleware 143 may serve as an intermediary for allowing the API 145 or the application program 147 to communicate with the kernel 141 and exchange data with the kernel 141. In addition, the middleware 143 may perform operations (e.g., scheduling or load balancing) for controlling work requests received from the application program 147, for example, by assigning a priority to each work request for using the system resources (e.g., the bus 110, the processor 120, the memory 130, or the like) of the electronic device 101 to at least one application of the application program 147.

The API 145 may be an interface for allowing the application program 147 to control a function provided by the kernel 141 or the middleware 143, and may include, for example, at least one interface or function (e.g., instructions) for controlling a file, controlling a window, processing an image, or controlling a text.

The input/output interface 150 may serve as an interface for transmitting instructions or data input from a user or another external device to the other element(s) of the electronic device 101. Furthermore, the input/output interface 150 may output the instructions or data received from other element(s) of the electronic device 101 to the user or another external device.

Examples of the display 160 may include a liquid crystal display (LCD), a light-emitting diode (LED) display, an organic LED (OLED) display, a microelectromechanical systems (MEMS) display, and an electronic paper display. The display 160 may display, for example, various types of contents (e.g., text, images, videos, icons, or symbols) to a user. The display 160 may include a touch screen, and may receive, for example, a touch, gesture, proximity, or hovering input using an electronic pen or a user's body part.

The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication, and may communicate with an external device (e.g., the second external electronic device 104 or the server 106).

The wireless communication may use at least one of, for example, long term evolution (LTE), LTE-advanced (LTE-A), code division multiple access (CDMA), wideband CDMA (WCDMA), universal mobile telecommunications system (UMTS), wireless broadband (WiBro), and global system for mobile communications (GSM), as a cellular communication protocol. In addition, the wireless communication may include, for example, short range communication 164. The short-range communication 164 may include at least one of Wi-Fi, Bluetooth®, near field connection (NFC), and global navigation satellite system (GNSS). GNSS may include, for example, at least one of global positioning satellite (GPS), global navigation satellite system (GLONASS), a BeiDou Navigation satellite system (hereinafter referred to as “BeiDou”), or European global satellite-based navigation system (GALILEO), based on a location, a bandwidth, or the like. Hereinafter, in the present disclosure, the “GPS” may be interchangeably used with the “GNSS”. The wired communication may include, for example, at least one of a universal serial bus (USB), a high definition multimedia interface (HDMI), recommended standard-232 (RS-232), and a plain old telephone service (POTS). The network 162 may include at least one of a communication network such as a computer network (e.g., a local area network (LAN) or a wide area network (WAN)), the internet, and a telephone network.

Each of the first and second external electronic devices 102 and 104 may be of a type identical to or different from that of the electronic device 101. According to an embodiment of the present disclosure, the server 106 may include a group of one or more servers. According to various embodiments of the present disclosure, all or some of the operations performed in the electronic device 101 may be executed in another electronic device or a plurality of electronic devices (e.g., the electronic devices 102 and 104 or the server 106). According to an embodiment of the present disclosure, when the electronic device 101 performs functions or services automatically or in response to a request, the electronic device 101 may request another device (e.g., the electronic device 102 or 104 or the server 106) to execute at least some functions relating thereto instead of or in addition to autonomously performing the functions or services. Another electronic device (e.g., the electronic device 102 or 104, or the server 106) may execute the requested functions or the additional functions, and may deliver a result of the execution to the electronic device 101. The electronic device 101 may process the received result as it is or further process the received result to provide the requested functions or services. To this end, for example, cloud computing, distributed computing, or client-server computing technologies may be used.

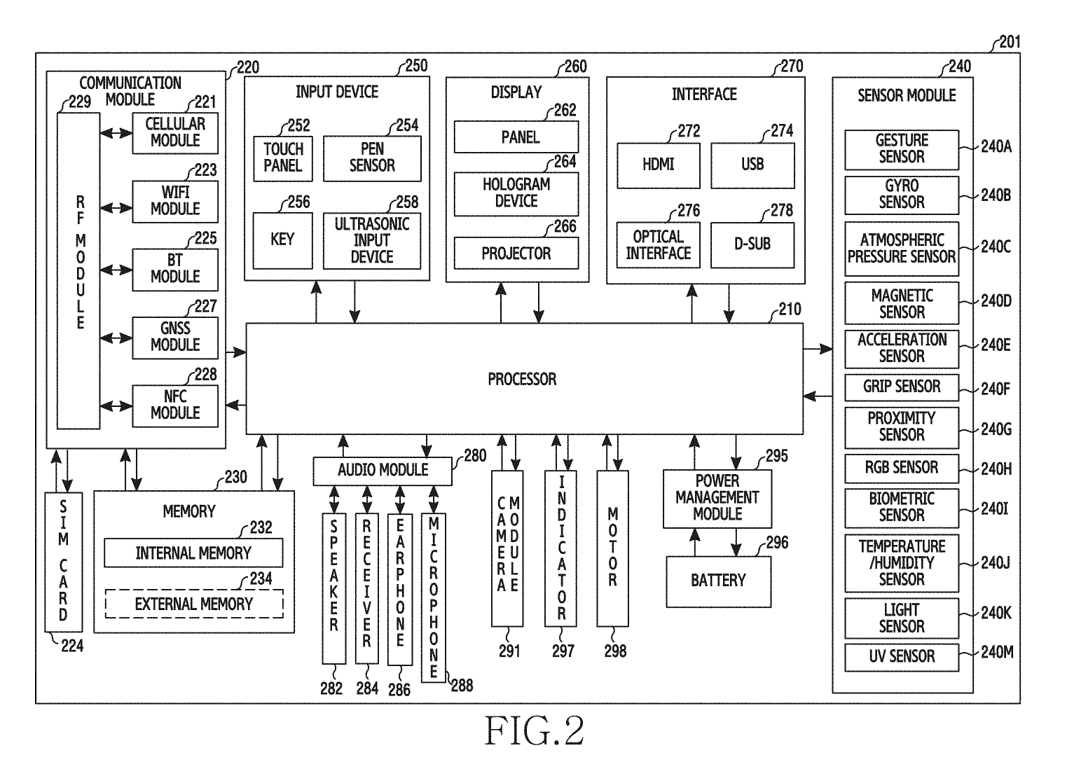

FIG. 2 is a block diagram illustrating an electronic device according to an embodiment of the present disclosure.

Referring to FIG. 2, the electronic device 201 may include, for example, all or a part of the electronic device 101 shown in FIG. 1. The electronic device 201 may include one or more processors 210 (e.g., APs), a communication module (or communication circuit) 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected thereto and perform processing of pieces of data and calculations by driving an OS or an application program. The processor 210 may be embodied as, for example, a system on chip (SoC). According to an embodiment of the present disclosure, the processor 210 may further include at least a graphics processing unit (GPU) or an image signal processor (ISP). The processor 210 may include at least some of the components (e.g., a cellular module 221) illustrated in FIG. 2. The processor 210 may load, into a volatile memory, commands or data received from at least one other component (e.g., a non-volatile memory) into a volatile memory to process the loaded commands or data, and may store various data in a non-volatile memory.

The communication module 220 may have a configuration equal or similar to that of the communication interface 170 of FIG. 1. The communication module 220 may include, for example, a cellular module 221, a Wi-Fi module 223, a Bluetooth® (BT) module 225, a GPS module 227 (e.g., a GPS module 227, a GLONASS module, a BeiDou module, or a GALILEO module), an NFC module 228, and a radio frequency (RF) module 229.

The cellular module 221, for example, may provide a voice call, a video call, a text message service, or an Internet service through a communication network. According to an embodiment of the present disclosure, the cellular module 221 may distinguish and authenticate the electronic device 201 in a communication network using a subscriber identification module 224 (e.g., the SIM card). According to an embodiment of the present disclosure, the cellular module 221 may perform at least some of the functions that the processor 210 may provide. According to an embodiment of the present disclosure, the cellular module 221 may include a CP.

Each of the Wi-Fi module 223, the BT module 225, the GNSS or GPS module 227, and the NFC module 228 may include a processor for processing data transmitted/received through a corresponding module. According to an embodiment of the present disclosure, at least some (e.g., two or more) of the cellular module 221, the Wi-Fi module 223, the BT module 225, the GNSS module 227, and the NFC module 228 may be included in a single integrated chip (IC) or IC package.

The RF module 229, for example, may transmit/receive a communication signal (e.g., an RF signal). The RF module 229 may include, for example, a transceiver, a power amplifier module (PAM), a frequency filter, a low noise amplifier (LNA), and an antenna. According to an embodiment of the present disclosure, at least one of the cellular module 221, the Wi-Fi module 223, the BT module 225, the GNSS module 227, and the NFC module 228 may transmit/receive an RF signal through a separate RF module.

The subscriber identification module (SIM 224) may include, for example, a card including a subscriber identity module or an embedded SIM, and may further include unique identification information (e.g., an integrated circuit card identifier (ICCID)) or subscriber information (e.g., an international mobile subscriber identity (IMSI)).

The memory 230 (e.g., the memory 130) may include, for example, an embedded (or internal) memory 232 or an external memory 234. The embedded memory 232 may include at least one of a volatile memory (e.g., a dynamic random access memory (DRAM), a static RAM (SRAM), a synchronous DRAM (SDRAM), or the like) and a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), a hard disc drive, or a solid state drive (SSD)).

The external memory 234 may further include a flash drive, for example, a compact flash (CF), a secure digital (SD), a micro-SD, a mini-SD, an extreme digital (xD), a multimedia card (MMC), a memory stick, or the like. The external memory 234 may be functionally and/or physically connected to the electronic device 201 through various interfaces.

The sensor module 240 may be configured to measure a physical quantity or detect an operation state of the electronic device 201, and convert the measured or detected information into an electrical signal. The sensor module 240 may include, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color sensor 240H (e.g., red, green, and blue (RGB) sensor), a biometric sensor (medical sensor) 240I, a temperature/humidity sensor 240J, a light sensor 240K, and an ultraviolet light (UV) sensor 240M. Additionally or alternatively, the sensor module 240 may further include one or more sensors (not shown), including an electronic nose (E-nose) sensor, an electromyography (EMG) sensor, an electroencephalogram (EEG) sensor, an electrocardiogram (ECG) sensor, an infrared (IR) sensor, an iris scan sensor, and a finger scan sensor. The sensor module 240 may further include a control circuit for controlling one or more sensors included therein. According to an embodiment of the present disclosure, the electronic device 201 may further include another processor configured to control the sensor module 240, as a part of the processor 210 or a separate component from the processor 210 in order to control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor (digital pen or stylus) 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) may include a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 may include, for example, an HDMI 272, a USB 274, an optical interface 276, or a D-subminiature (D-sub) 278. The interface 270 may be included in, for example, the communication interface 170 illustrated in FIG. 1. Additionally or alternatively, the interface 270 may include, for example, a mobile high-definition link (MHL) interface, an SD card/MMC interface, or an infrared data association (IrDA) standard interface.

As illustrated in FIG. 2, the audio module 280, for example, may be configured to bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image, a moving image, or a video. According to an embodiment of the present disclosure, the camera module 291 may include one or more image sensors (e.g., a front sensor or a rear sensor), a lens, an internet service provider (ISP) or a flash (e.g., LED or xenon lamp).

The power management module 295 may manage, for example, power of the electronic device 201. According to an embodiment of the present disclosure, the power management module 295 may include a power management IC (PMIC), a charger IC, or a battery or fuel gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may be further included. The battery gauge may measure, for example, a residual quantity of the battery 296, and a voltage, a current, or a temperature while charging. The battery 296 may include, for example, at least one of a rechargeable battery and a solar battery.

The indicator 297 may indicate a state (e.g., a booting state, a message state, a charging state, or the like) of the electronic device 201 or a part (e.g., the processor 210) of the electronic device 201. The motor 298 may convert an electrical signal into a mechanical vibration, and may generate a vibration, a haptic effect, or the like. Although not illustrated, the electronic device 201 may include a processing device (e.g., a GPU) for supporting a mobile TV. The processing device for supporting a mobile TV may process, for example, media data according to certain standards such as digital multimedia broadcasting (DMB), digital video broadcasting (DVB), or media flow.

According to an embodiment, the processor 210 may provide an overseas roaming service through network settings.

For example, the processor 210 may be turned on. For example, the electronic device 101 may be turned on by a user. For example, when the user selects a power button for turning on the electronic device 101, the electronic device 101 may be turned on.

For example, the processor 210 may detect a public land mobile network (PLMN) list from a subscriber identification module (for example, the SIM card 224 or a universal IC card (UICC)). For example, the electronic device 101 may detect at least one of a last registered PLMN (RPLMN), a home PLMN (HPLMN) (or equivalent home PLMN (EHPLMN)), a user-controlled PLMN list, and an operator-controlled PLMN list from the subscriber identification module.

For example, the RPLMN may indicate a PLMN in which the electronic device 101 has recently registered. For example, the HPLMN may indicate a PLMN to which the electronic device 101 is subscribed. For example, the EHPLMN may indicate a PLMN equivalent to the HPLMN. For example, the user-controlled PLMN list can be controlled (for example, detected and updated) by the electronic device 101. For example, the user-controlled PLMN list may include 8 to N PLMNs. For example, the user-controlled PLMN list may be included in a “user-controlled PLMN selector with access technology” file of the SIM card 224. In another example, the user-controlled PLMN list may be stored in an “EFPLMNwACT” file of the UICC.

For example, the operator-controlled PLMN list can be controlled (for example, detected and updated) by a mobile communication service provider and only detected by the processor 210. For example, the operator-controlled PLMN list may include 8 to N PLMNs. For example, the operator-controlled PLMN list may be included in an “operator-controlled PLMN selector with access technology” file of the SIM card 224. In another example, the operator-controlled PLMN list may be stored in an “EFPLMNwAcT” file of the UICC.

For example, the processor 210 may select a PLMN from the PLMN list. According to an embodiment, the processor 210 may select the PLMNs from the PLMN lists in an order of the RPLMN, the HPLMN (or EHPLMN), at least one PLMN included in the user-controlled PLMN list, and at least one PLMN included in the operator-controlled PLMN list. According to an embodiment, when the user-controlled PLMN list includes a plurality of PLMNs, the processor 210 may select one of the plurality of PLMNs according to a predetermined priority. According to an embodiment, when the operator-controlled PLMN list includes a plurality of PLMNs, the processor 210 may select one of the plurality of PLMNs according to a predetermined priority.

For example, the processor 210 may identify whether the electronic device 101 is registered in the network based on the selected PLMN. For example, the network may be a cellular network operated by a service provider corresponding to the selected PLMN.

For example, when there is no PLMN, which can be used for network registration or can be accepted, in the plurality of PLMNs, the processor 210 may not provide the communication service. For example, the processor 210 may block a voice service (for example, a circuit switch (CS) service) or a data service (for example, a packet switch (PS) service) through cellular communication. For example, the processor 210 may provide the data service through a wireless communication other than the cellular communication. For example, the wireless communication other than the cellular communication may include at least one of Wi-Fi, NFC, and BT.

For example, when the electronic device 101 is registered in the network, the processor 210 may determine the selected PLMN as a visited PLMN (VPLMN). For example, the VPLMN may indicate a PLMN in which the electronic device 101 is registered. For example, the electronic device 101 registered in the network may provide the CS service through the network.

For example, the processor 210 may identify whether a data roaming service is activated. For example, the data roaming service may be a service that enables data communication by informing the electronic device 101 that a network moves when the user moves to a geographically separated network.

For example, when the data roaming service is activated, the processor 210 may receive PLMN information and update the user-controlled PLMN list based on the received PLMN information. For example, the PLMN information may include at least one preferred roaming PLMN for a local country and a neighboring country corresponding to the electronic device 101. For example, the preferred roaming PLMN may be at least one PLMN corresponding to at least one service provider who has made a roaming contract with a home network service provider of the electronic device 101 among all PLMNs of the local country and the neighboring country.

For example, when the VPLMN exists in the PLMN information, the processor 210 may provide the data service through the registered network. For example, the processor 210 may determine that the registered network is a network operated by the service provider who has made the data roaming contract with the home network service provider of the electronic device 101 and provide the packet switched (PS) service through the registered network according to a payment plan of the data roaming contract. For example, the payment plan of the data roaming contract may be a limitless payment plan by which the user can limitlessly receive data for a predetermined amount of money.

For example, the processor 210 may transmit a packet data protocol (PDP) context request to a base station included in the registered network and perform a process of receiving the data service from the registered network. For example, the PDP context request may indicate a message that makes a request for PDP context. For example, the PDP context may be a set of information for a connection with an external packet data network (for example, the registered network). The PDP context may serve to provide a connection for transmission/reception of packet data between the electronic device 101 and the network.

For example, when the VPLMN does not exist in the PLMN information, the processor 210 may determine that the registered network is a network operated by a service provider who has not made the data roaming contract with the home network service provider of the electronic device 101. The processor 210 may display a data service query message and identify whether a request for the data service is made through the displayed data service query message. For example, the data service query message may be a message that asks about whether to provide the data service through the registered network.

For example, when the request for the data service is made, the processor 210 may provide the PS service through the registered network according to a payment plan of the corresponding service provider. For example, the payment plan of the corresponding service provider may be more expensive than the payment plan of the data roaming contract.

For example, when the request for the data service is not made, the processor 210 may not provide the data service. For example, the processor 210 may provide only the CS service without providing the PS service.

According to an embodiment, the processor 210 may update the PLMN information stored in the memory 230 based on the user-controlled PLMN list stored in the SIM card 224.

According to an embodiment, the processor 210 may update the PLMN information stored in the memory 230 based on the PLMN information received from the server 106. For example, the processor 210 may receive the PLMN information from the server 106 and update the PLMN information stored in the memory 230 based on the received PLMN information. For example, the electronic device 101 may store at least one preferred roaming PLMN for the local country and the neighboring country in the memory 230.

For example, the processor 210 may receive the PLMN information through a message service. More specifically, the processor 210 may make a request for the PLMN information to the server 106 through the message service. For example, the message service may include a SMS, a social network service (SNS), or a chatting service using the CS service. For example, the processor 210 may store a unique identifier (for example, a phone number or a server address) of the service 106 in the memory 230 and transmit a request message that makes a request for the PLMN information to the server 106 based on the unique identifier of the server 106. For example, the request message may include an HPLMN and a unique identifier (for example, a phone number) of the electronic device 101.

In another example, the processor 210 may receive the PLMN information through wireless communication. For example, the processor 210 may transmit the request message that makes the request for the PLMN information to the server 106 through wireless communication and receive the PLMN information from the server 106 in response to the request message. For example, the wireless communication may be wireless communication which does not generate a data communication fee. For example, the wireless communication may be Wi-Fi. For example, the request message may include an HPLMN and a unique identifier (for example, a media access control (MAC) address or an internet protocol (IP) address) of the electronic device 101.

According to an embodiment, even though the request for the PLMN information is not made, the processor 210 may automatically receive the PLMN information from a base station connected to the electronic device 101 through the SMS and update the PLMN information stored in the memory 230 based on the received PLMN information.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

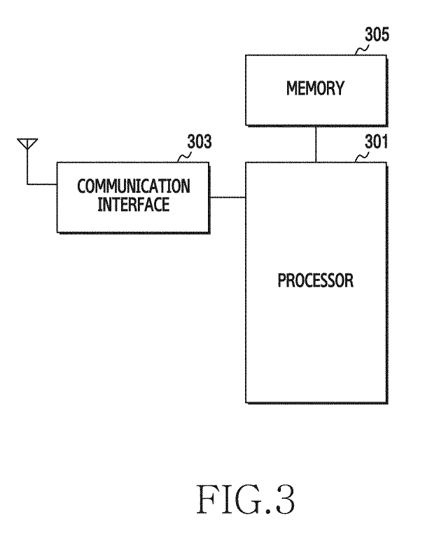

FIG. 3 is a block diagram of the server according to an embodiment of the present disclosure.

For example, the server may be the server 106 illustrated in FIG. 1. For example, the server may be a base station. For example, the server 106 may be an external electronic device.

Referring to FIG. 3, the server 106 may include a processor 301, a communication interface 303, and a memory 305.

Hereinafter, each element will be described. The communication interface 303 may support cellular communication and transmit or receive a signal to or from at least one electronic device within the cell. For example, the communication interface 303 may transmit or receive a signal to or from the electronic device 101. For example, the communication interface 303 may include an RF processor and a base band processor. For example, the RF processor may perform a function of transmitting and receiving a signal through a radio channel such as converting or amplifying a band of the signal. That is, the RF processor may up-convert a base band signal provided from the base band processor into an RF band signal, transmit the up-converted signal through an antenna, and then down-convert the RF band signal received through the antenna into a base band signal. For example, the RF processor may include a transmission filter, a reception filter, an amplifier, a mixer, an oscillator, a digital to analog convertor (DAC), an analog to digital convertor (ADC), and the like.

According to an embodiment, the communication interface 303 may support Wi-Fi communication, and transmit or receive a signal to or from at least one electronic device within the cell. According to an embodiment, the communication interface 303 may transmit or receive a signal to or from at least one electronic device within the cell through a network (for example, the network 162).

The base band processor may perform a function of conversion between a base band signal and a bitstream according to a physical layer standard of the system. For example, when transmitting data, the base band processor may generate complex symbols by encoding and modulating a transmission bitstream. Further, when receiving data, the base band processor may reconstruct a reception bitstream by demodulating and decoding the base band signal provided from the RF processor. For example, in an orthogonal frequency-division multiplexing (OFDM) scheme, when transmitting data, the base band processor may generate complex symbols by encoding and modulating the transmission bitstream, map the complex symbols to subcarriers, and then configure OFDM symbols through an inverse fast Fourier transform (IFFT) operation and CP insertion. Further, when receiving data, the base band processor may divide the base band signal provided from the RF processor in the unit of OFDM symbols, reconstruct the signals mapped to the subcarriers through an FFT operation, and then reconstruct the reception bitstream through demodulation and decoding. The base band processor and the RF processor may transmit or receive the signal as described above. For example, the communication interface 303 may be referred to as a transmitter, a receiver, a transceiver, or a wireless communication interface.

The memory 305 may store a basic program for an operation of the server 106, an application program, and data such setting information. According to an embodiment, the memory 305 may store at least one PLMN which has made a roaming contract with the corresponding PLMN according to each PLMN. According to an embodiment, the memory 305 may store PLMN information corresponding to the electronic device 101. For example, the PLMN information may include at least one preferred roaming PLMN. For example, at least one preferred roaming PLMN may be a PLMN corresponding to at least one service provider who has made a roaming contract with a home network service provider of the electronic device 101 among all PLMNs of the local country and the neighboring country.

The processor 301 may control general operations of the server 106. For example, the processor 301 may transmit and receive a signal through the communication interface 303. Further, the processor 301 may record data in the memory 305 or read the data.

According to an embodiment, the processor 301 may transmit the PLMN information to the electronic device 101 according to a request of the electronic device 101. For example, the processor 301 may transmit the PLMN information to the electronic device 101 through a message service. For example, the message service may be an SMS transmitted and received through the CS service.

According to an embodiment, the processor 301 may receive a request message that makes a request for the PLMN information from the electronic device 101 through the message service. For example, the request message may include an HPLMN and a unique identifier (for example, a phone number) of the electronic device 101. The processor 301 may search for at least one preferred roaming PLMN corresponding to the HPLMN of the electronic device 101 in the memory 305 based on the HPLMN of the electronic device 101. The processor 301 may generate PLMN information including at least one found preferred roaming PLMN and transmit the generated PLMN information to the electronic device 101 based on a unique identifier of the electronic device 101.

According to another embodiment, the processor 301 may receive the request message that makes the request for the PLMN information from the electronic device 101 through wireless communication. For example, the request message may include an HPLMN and a unique identifier (for example, an IP address or a MAC address) of the electronic device 101. The processor 301 may search for at least one preferred roaming PLMN corresponding to the HPLMN of the electronic device 101 in the memory 305 based on the HPLMN of the electronic device 101. The processor 301 may generate PLMN information including at least one found preferred roaming PLMN and transmit the generated PLMN information to the electronic device 101 based on a unique identifier of the electronic device 101.

In another example, the processor 301 may transmit the PLMN information to the electronic device 101 through the base station according to a request of the base station. For example, the base station may be a base station included in the network in which the electronic device 101 is registered.

According to an embodiment, the processor 301 may receive the request message that makes the request for the PLMN information of the electronic device 101 from the base station. For example, the request message may include HPLMN information of the electronic device 101. The processor 301 may search for at least one preferred roaming PLMN corresponding to the HPLMN of the electronic device 101 in the memory 305 based on the HPLMN of the electronic device 101. Further, the processor 301 may generate PLMN information including at least one found preferred roaming PLMN and transmit the generated PLMN information to the base station.

According to an embodiment, when the PLMN information is received, the base station may transmit the received PLMN information to the electronic device 101 based on a unique identifier (for example, a phone number) of the electronic device 101 through the message service. For example, the base station may store the unique identifier of the electronic device 101 in advance.

According to an embodiment, an electronic device may include: a communication circuit; a memory; a display; a subscriber identification module; and a processor, wherein the processor may register in an external electronic device through a network having a first PLMN by using the communication circuit, acquire a user-controlled PLMN list related to roaming from the subscriber identification module, and control the display to display a message asking whether to use a data service when the first PLMN is not included in the user-controlled PLMN list.

According to an embodiment, the user-controlled PLMN list may include a PLMN of at least one service provider having a data roaming contract with a home network service provider related to the electronic device.

According to an embodiment, the processor may update PLMN information stored in the memory based on at least one PLMN included in the user-controlled PLMN list.

According to an embodiment, the processor may control the communication circuit to transmit a signal for requesting PLMN information related to roaming to another external device by using the communication circuit through a message service and receive the PLMN information from the network through the message service in response to the request.

According to an embodiment, the processor may update the user-controlled PLMN list based on the received PLMN information.

According to an embodiment, the electronic device may further include another communication circuit, and the processor may control the communication circuit to transmit a signal for requesting PLMN information related to the roaming to another external electronic device by using the other communication circuit, receive the PLMN information from the other external electronic device through the communication circuit in response to the request, and update the user-controlled PLMN list based on the received PLMN information.

According to an embodiment, when the first PLMN is not included in the user-controlled PLMN list, the processor may control the display to display a message asking about provision of the data service and, when the provision of the data service is selected through the message, provide the data service through the network.

According to an embodiment, when the provision of the data service is not selected through the message, the processor may block the provision of the data service through the network.

According to an embodiment, when the electronic device leaves an area of the network, the processor may register the electronic device in another network based on a second PLMN and, when the second PLMN is included in the user-controlled PLMN list, provide a data service through the other network.

According to an embodiment, when the second PLMN is not included in the user-controlled PLMN list, the processor may control the display to display a message asking about provision of the data service through the other network.

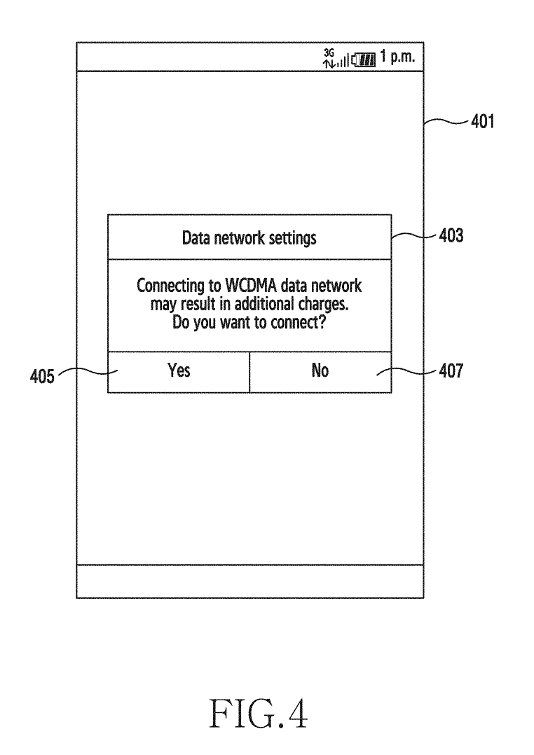

FIG. 4 illustrates that a data service query message is displayed according to an embodiment of the present disclosure.

Referring to FIG. 4, the electronic device (for example, the electronic device 101) may display a data service query message. For example, the data service query message may be a message that asks about whether to provide the data service through the registered network. For example, the registered network may be a network operated by a service provider who has not made a data roaming contract with a home network service provider of the electronic device 101.

For example, the electronic device 101 may display a data service query message 403 that asks about whether to connect to the registered network (for example, a WCDMA data network) as shown in a screen 401.

According to an embodiment, the electronic device 101 may identify whether a request for a data service is made through the displayed data service query message.

For example, when the user selects Yes 405 of the data service query message 403 on the screen 401, the electronic device 101 may determine that the request for the data service is made. In another example, when the user selects No 407 of the data service query message 403 on the screen 401, the electronic device 101 may determine that the request for the data service is not made.

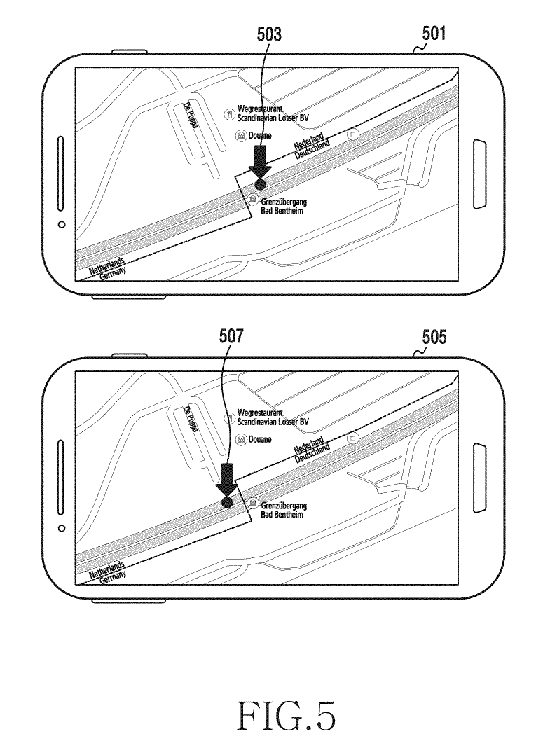

FIG. 5 illustrates that a data service is provided according to an embodiment of the present disclosure.

Referring to FIG. 5, when the electronic device (for example, the electronic device 101) escapes an area of the registered network during the data service, the electronic device may be automatically connected to another network in which the roaming service is possible, so that the data service can be smoothly provided.

For example, the electronic device 101 may perform a particular function through the data service. For example, the particular function refers to a function based on the data service and may include at least one of, for example, a navigation function, a game, and a messaging function. For example, the electronic device 101 may display a current location 503 of the electronic device 101 as shown in a screen 501 by providing the navigation function.

For example, since the PLMNs are different depending on each country and each service provider, if the electronic device 101 crosses the border, the electronic device 101 may escape from the area of the registered network. For example, as shown in the screen 501, when the electronic device 101 crosses the border of Germany and moves to the Netherlands, the electronic device 101 may escape from the area of the registered network.

For example, when the electronic device 101 escapes from the area of the registered network, the electronic device 101 may select one of the PLMNs stored in the SIM card (for example, the SIM card 224) and register in a particular network based on the selected PLMN.

For example, the electronic device 101 may identify whether the selected PLMN exists in the user-controlled PLMN list stored in the memory 230. For example, the stored PLMN information may include at least one preferred roaming PLMN of the local country or the neighboring country corresponding to the electronic device 101.

When the selected PLMN exists in the PLMN information based on a result of the identification, the electronic device 101 may continuously provide the data service through the registered network. For example, the electronic device 101 may display a current location 507 of the electronic device 101 by continuously performing the navigation function as shown in a screen 505.

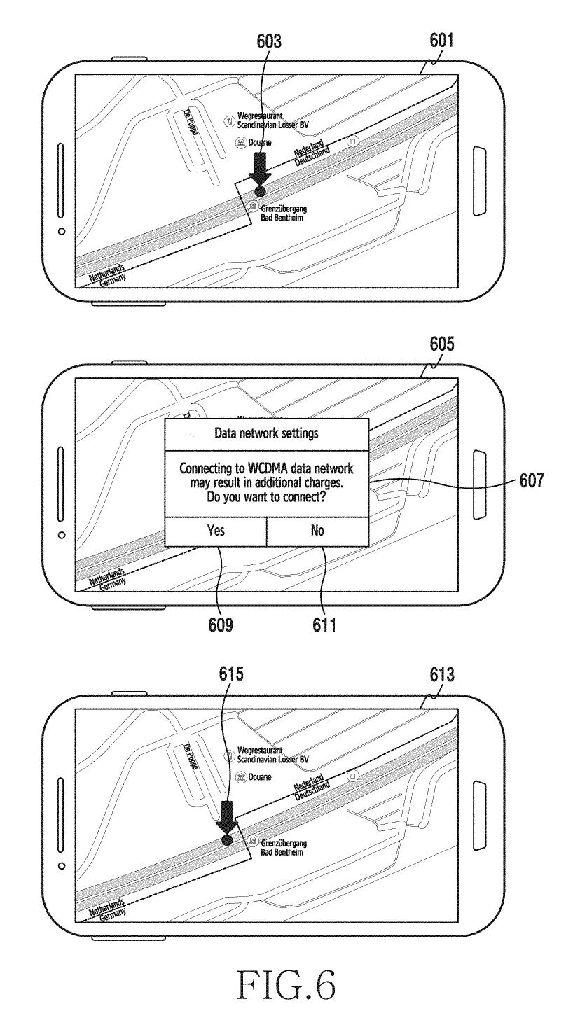

FIG. 6 illustrates that a data service is provided according to an embodiment of the present disclosure.

Referring to FIG. 6, when the electronic device (for example, the electronic device 101) escapes from an area of the registered network during the data service, the electronic device may be connected to another network in which the data service is possible, so that the data service can be smoothly provided.

For example, the electronic device 101 may perform a particular function through the data service. For example, the electronic device 101 may display a current location 603 of the electronic device 101 as shown in a screen 601 by providing the navigation function.

For example, since the PLMNs are different depending on each country and each service provider, when the electronic device 101 crosses the border, the electronic device 101 may escape from the area of the registered network. For example, as shown in the screen 601, when the electronic device 101 crosses the border of Germany and moves to the Netherlands, the electronic device 101 may escape from the area of the registered network.

For example, when the electronic device 101 escapes from the area of the registered network, the electronic device 101 may select one of the PLMNs stored in the SIM card (for example, the SIM card 224) and register in a particular network based on the selected PLMN.

For example, the electronic device 101 may identify whether the selected PLMN exists in the PLMN information stored in the memory 230. When the selected PLMN does not exist in the PLMN information based on a result of the identification, the electronic device 101 may display a data service query message. For example, the registered network may be a network operated by a service provider who has not made a data roaming contract with a home network service provider of the electronic device 101.

For example, the electronic device 101 may display a data service query message 607 that asks about whether to connect to the registered network (for example, a WCDMA data network) as shown in a screen 605.

For example, the electronic device 101 may identify whether a request for the data service is made through the displayed data service query message. For example, when the user selects Yes 609 of the data service query message 607 on the screen 605, the electronic device 101 may determine that the request for the data service is made. In another example, when the user selects No 611 of the data service query message 607, the electronic device 101 may determine that the request for the data service is not made.

When the request for the data service is made based on a result of the identification, the electronic device 101 may provide the data service through the registered network. For example, the electronic device 101 may display a current location 615 of the electronic device 101 by continuously performing the navigation function as shown in a screen 613.

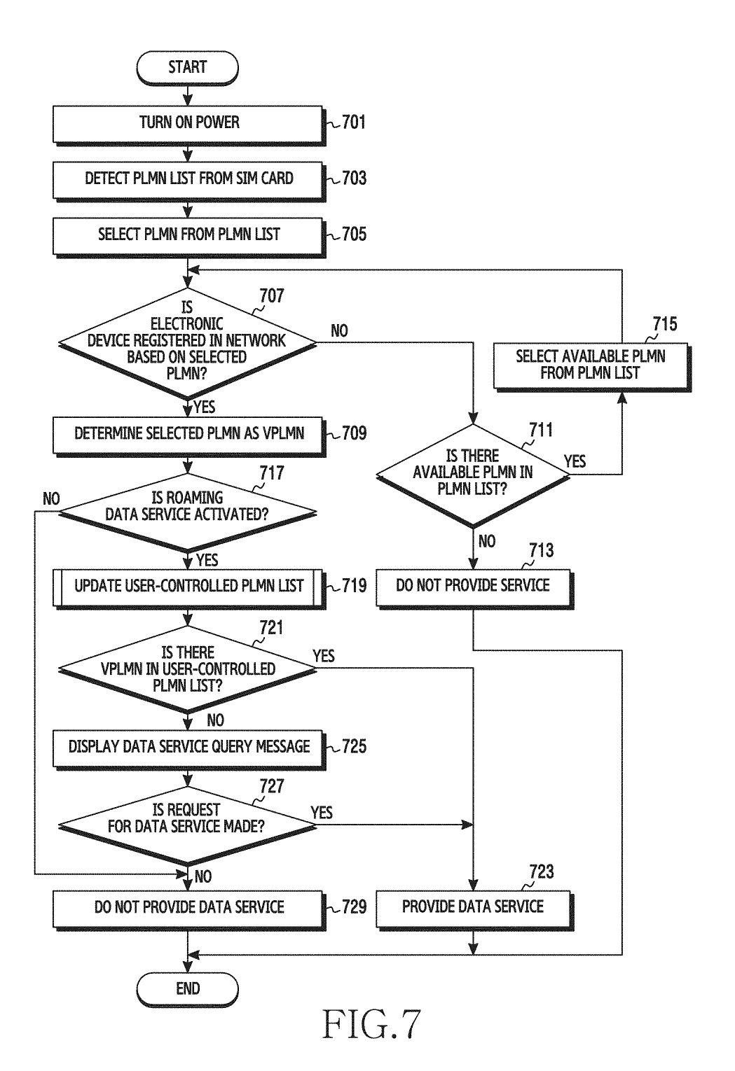

FIG. 7 is a flowchart illustrating an operation of providing a data service according to an embodiment of the present disclosure.

For example, the operation in the flowchart of FIG. 7 may be performed by the electronic device (for example, the electronic device 101 or the electronic device 201). For example, the operation in the flowchart of FIG. 7 may be performed by the processor 120 of the electronic device 101 or the processor 210 of the electronic device 201.

Referring to FIG. 7, in operation 701, the electronic device 101 (for example, the processor 210) may be turned on. For example, the electronic device 101 (for example, the processor 210) may be turned on by the user. For example, when the user selects a power button for turning on the electronic device 101, the electronic device 101 (for example, the processor 210) may be turned on.

In operation 703, the electronic device 101 (for example, the processor 210) may detect a PLMN list from the subscriber identification module (for example, the SIM card 224 or the UICC). For example, the electronic device 101 (for example, the processor 210) may acquire at least one of the RPLMN, the HPLMN (or EHPLMN), the user-controlled PLMN list, and the operator-controlled PLMN list from the subscriber identification module.

In operation 705, the electronic device 101 (for example, the processor 210) may select a PLMN from the PLMN list. According to an embodiment, the electronic device 101 (for example, the processor 210) may select the PLMN from the PLMN list in an order of the RPLMN, the HPLMN (or EHPLMN), at least one PLMN included in the user-controlled PLMN list, and at least one PLMN included in the operator-controlled PLMN list. According to an embodiment, when the user-controlled PLMN list includes a plurality of PLMNs, the electronic device 101 (for example, the processor 210) may select one of the plurality of PLMNs according to a predetermined priority. According to an embodiment, the operator-controlled PLMN list includes a plurality of PLMNs, the electronic device 101 (for example, the processor 210) may select one of the plurality of PLMNs according to a predetermined priority.

In operation 707, the electronic device 101 (for example, the processor 210) may identify whether the electronic device 101 is registered in the network based on the selected PLMN. For example, the network may be a cellular network operated by a service provider corresponding to the selected PLMN. When the electronic device 101 is registered in the network based on a result of the identification, the electronic device 101 (for example, the processor 210) may perform operation 709. Otherwise, the electronic device 101 (for example, the processor 210) may perform operation 711.

In operation 711, the electronic device 101 (for example, the processor 210) may identify whether an available PLMN is included in the PLMN list. For example, the available PLMN may indicate a PLMN that has not failed network registration among the PLMNs included in the PLMN list. When the available PLMN is included based on a result of the identification, the electronic device 101 (for example, the processor 210) may perform operation 715. Otherwise, the electronic device 101 (for example, the processor 210) may perform operation 713.

In operation 715, the electronic device 101 (for example, the processor 210) may select the available PLMN from the PLMN list and then perform operation 707.

In operation 713, the electronic device 101 (for example, the processor 210) may not provide the communication service. For example, the electronic device 101 (for example, the processor 210) may block the CS service and the PS service through cellular communication. For example, the electronic device 101 (for example, the processor 210) may provide the data service through other wireless communication except for the cellular communication. For example, the other wireless communication except for the cellular communication may include at least one of Wi-Fi, NFC, and Bluetooth.

In operation 709, the electronic device 101 (for example, the processor 210) may determine the selected PLMN as the VPLMN. For example, the VPLMN may indicate a PLMN in which the electronic device 101 is registered. For example, the electronic device 101 registered in the network may provide the CS service through the network.

In operation 717, the electronic device 101 (for example, the processor 210) may identify whether the data roaming service is activated. For example, the data roaming service may be a service that enables the data communication by informing the electronic device 101 (for example, the processor 210) that the network moves when the user moves to the geographically separated network.

For example, when the electronic device 101 (for example, the processor 210) subscribes to the data roaming service, the electronic device 101 (for example, the processor 210) may determine that the data roaming service is activated. In another example, when the electronic device 101 (for example, the processor 210) does not subscribe to the data roaming service, the electronic device 101 (for example, the processor 210) may determine that the data roaming service is deactivated.

When the data roaming service is activated based on a result of the identification, the electronic device 101 (for example, the processor 210) may perform operation 719. Otherwise, the electronic device 101 (for example, the processor 210) may perform operation 729.

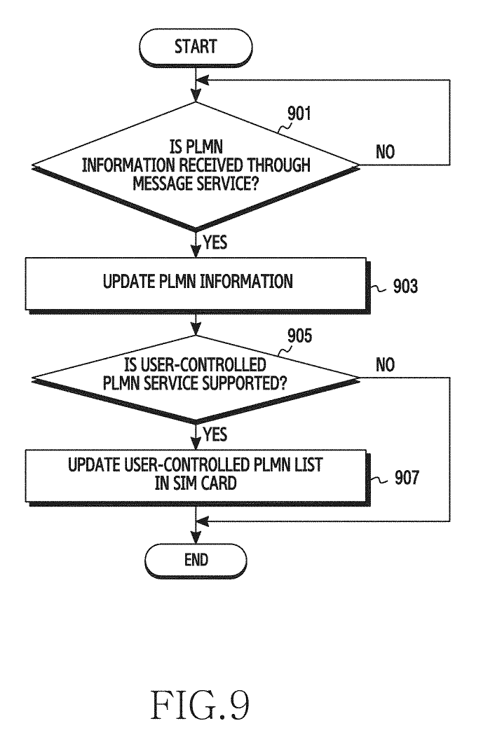

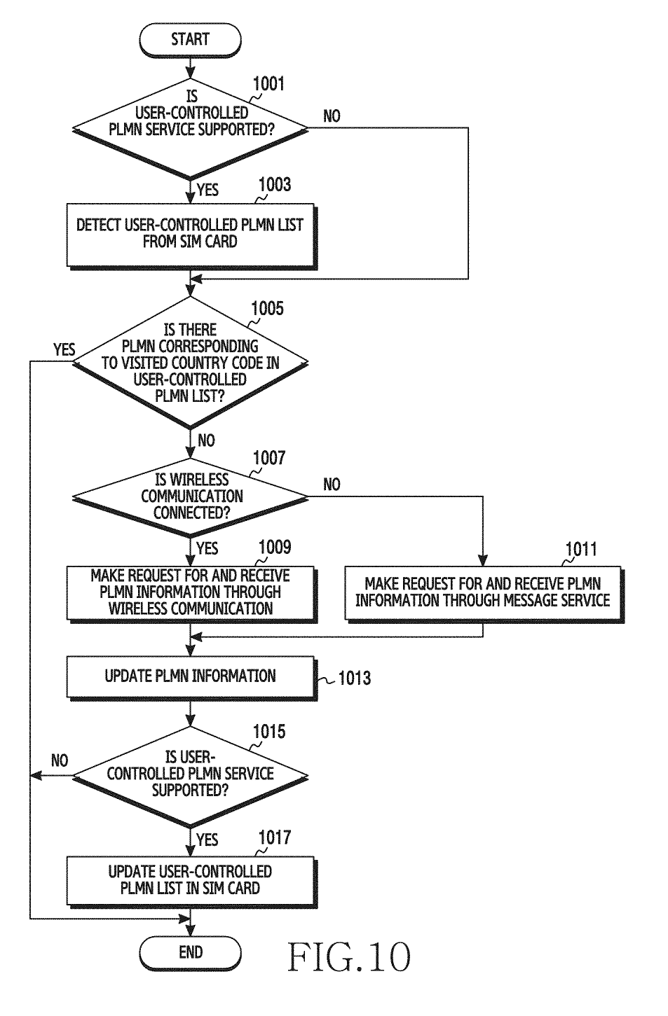

In operation 719, the electronic device 101 (for example, the processor 210) may update the user-controlled PLMN list. For example, the electronic device 101 (for example, the processor 210) may receive PLMN information from an external electronic device may update the user-controlled PLMN list based on the received PLMN information. For example, the PLMN information may include at least one preferred roaming PLMN for the local country and the neighboring country corresponding to the electronic device 101. For example, the preferred roaming PLMN may be at least one PLMN corresponding to at least one service provider who has made a contract with a home network service provider of the electronic device 101 among all PLMNs of the local country and the neighboring country. Hereinafter, operation 719 will be described in detail with reference to FIGS. 9 to 10.

In operation 721, the electronic device 101 (for example, the processor 210) may identify whether the VPLMN exists in the PLMN information. For example, when the VPLMN exists in the PLMN information, the electronic device 101 (for example, the processor 210) may perform operation 723. Otherwise, the electronic device 101 (for example, the processor 210) may perform operation 725.

In operation 725, the electronic device 101 (for example, the processor 210) may display a data service query message. For example, the data service query message may be a message that asks about whether to provide the data service through the registered network. For example, the registered network may be a network operated by a service provider who has not made a data roaming contract with a home network service related to the electronic device 101.

For example, as shown in the screen 401 of FIG. 4, the electronic device 101 (for example, the processor 210) may display the data service query message 403 that asks about whether to connect to the registered network (for example, a WCDMA data network).

In operation 727, the electronic device 101 (for example, the processor 210) may identify whether a request for the data service is made. For example, as shown in the screen 401 of FIG. 4, when the user selects Yes 405 of the data service query message 403, the electronic device 101 (for example, the processor 210) may determine that the request for the data service is made. In another example, as shown in the screen 401 of FIG. 4, when the user selects No 407 of the data service query message 403, the electronic device 101 (for example, the processor 210) may determine that the request for the data service is not made.

When the request for the data service is made based on a result of the identification, the electronic device 101 (for example, the processor 210) may perform operation 723. Otherwise, the electronic device 101 (for example, the processor 210) may perform operation 729.

In operation 723, the electronic device 101 (for example, the processor 210) may provide the data service through the registered network. For example, when the registered network is a network operated by the service provider who has made the data roaming contract with the home network service provider of the electronic device 101, the electronic device 101 (for example, the processor 210) may provide the PS service through the registered network according to a payment plan of the data roaming contract. For example, the payment plan of the data roaming contract may be a limitless payment plan by which the user can limitlessly receive data for a predetermined amount of money.

In another example, when the registered network is a network operated by the service provider who has not made the data roaming contract with the home network service provider of the electronic device 101, the electronic device 101 (for example, the processor 210) may provide the PS service through the registered network according to a payment plan of the corresponding service provider. For example, the payment plan of the corresponding service provider may be more expensive than the payment plan of the data roaming contract.

In operation 729, the electronic device 101 (for example, the processor 210) may not provide the data service through the registered network. For example, the electronic device 101 (for example, the processor 210) may provide the CS service through the registered network but block the PS service.

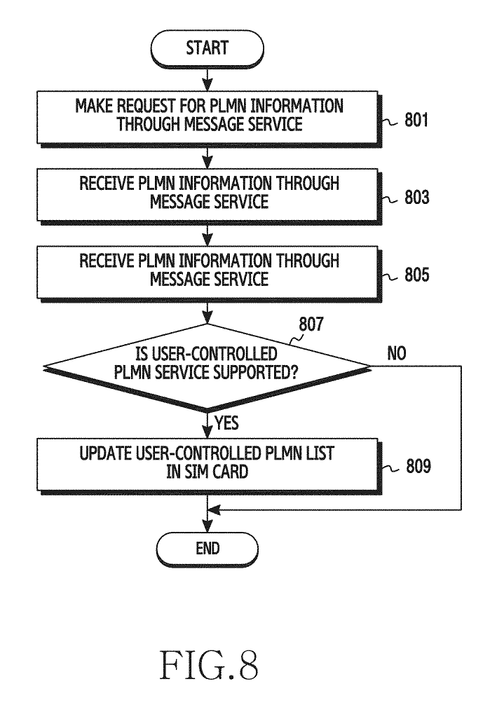

FIG. 8 is a flowchart illustrating an operation of updating a user-controlled PLMN list according to an embodiment of the present disclosure.

For example, the operation in the flowchart of FIG. 8 may be performed by the electronic device (for example, the electronic device 101). For example, the operation in the flowchart of FIG. 8 may be performed by the processor 120 of the electronic device 101 or the processor 210 of the electronic device 201.

Referring to FIG. 8, in operation 801, the electronic device 101 (for example, the processor 210) may make a request for PLMN information to the server (for example, the server 106) through a message service. For example, the message service may be an SMS transmitted and received through the CS service. For example, the PLMN information may include at least one preferred roaming PLMN for the local country and the neighboring country corresponding to the electronic device 101.

For example, the electronic device 101 (for example, the processor 210) may store a unique identifier (for example, a phone number) of the server 106 in the memory (for example, the memory 130 or the memory 230) and transmit a request message that makes a request for the PLMN information to the server 106 based on the unique identifier of the server 106. For example, the request message may include an HPLMN and a unique identifier (for example, a phone number) of the electronic device 101.

According to an embodiment, when the request message is received, the server 106 may search for at least one preferred roaming PLMN corresponding to an HPLMN of the electronic device 101 in the memory (for example, the memory 305) based on the HPLMN of the electronic device 101. For example, at least one preferred roaming PLMN corresponding to the HPLMN of the electronic device 101 may be a PLMN of a service provider who has made a roaming contract with a home network service provider of the electronic device 101 among PLMNs of all service providers of the local country and the neighboring country. Further, the server 106 may generate PLMN information including at least one found preferred roaming PLMN and transmit the generated PLMN information to the electronic device 101 based on the unique identifier of the electronic device 101. For example, the number of preferred roaming PLMNs included in the PLMN information may be determined according to the size of an SMS message. For example, the PLMN information may include 8 preferred roaming PLMNs.

In operation 803, the electronic device 101 (for example, the processor 210) may receive the PLMN information from the server 106 through the message service. In operation 805, the electronic device 101 (for example, the processor 210) may update the PLMN information. For example, the electronic device 101 (for example, the processor 210) may update the PLMN information stored in the memory 230 based on the received PLMN information. For example, the electronic device 101 (for example, the processor 210) may store at least one preferred roaming PLMN for the local country and the neighboring country in the memory 230.

In operation 807, the electronic device 101 (for example, the processor 210) may identify whether a user-controlled PLMN service is supported. For example, the user-controlled PLMN service may be a service through the electronic device 101 (for example, the processor 210) controls (for example, detects or updates) the user-controlled PLMN list stored in the SIM card 224. The home network service provider of the electronic device 101 may set the electronic device 101 to support or not support the user-controlled PLMN service. Accordingly, in order to identify whether the user-controlled PLMN list can be updated in the SIM card 224, the electronic device 101 (for example, the processor 210) may identify whether the user-controlled PLMN service is supported.

When the user-controlled PLMN service is supported, the electronic device 101 (for example, the processor 210) may perform operation 809. Otherwise, the electronic device 101 (for example, the processor 210) may end a process of updating the user-controlled PLMN list.

In operation 809, the electronic device 101 (for example, the processor 210) may update the user-controlled PLMN list in the SIM card 224. For example, the electronic device 101 (for example, the processor 210) may update the user-controlled PLMN list based on the received PLMN information.

For example, the electronic device 101 (for example, the processor 210) may update the user-controlled PLMN list in consideration of the size of a file (for example, “User Controlled PLMN Selector with Access Technology” of the SIM card 224 or “EFPLMNwAcT” of the UICC) that stores the user-controlled PLMN list and changeability of the size. For example, when the size of “EFPLMNwAcT” is fixed and only 8 PLMNs can be stored, the electronic device 101 (for example, the processor 210) may detect 8 PLMNs in the received PLMN information and store the detected PLMNs in “EFPLMNwAcT”.

As described above, the electronic device 101 (for example, the processor 210) may update the user-controlled PLMN list of the SIM card 224 to include at least one preferred roaming PLMN. Due to the update, when selecting a network in the future, the electronic device 101 (for example, the processor 210) (or the processor 210) may first select at least one preferred roaming PLMN included in the user-controlled PLMN list according to a procedure of the automatic network selection mode without transmitting a preferred roaming PLMN to a modem protocol stack of the CP through a separate method.

FIG. 9 is a flowchart illustrating an operation of updating a user-controlled PLMN list according to an embodiment of the present disclosure.

For example, the operation in the flowchart of FIG. 9 may be performed by the electronic device (for example, the electronic device 101 or the electronic device 201). For example, the operation in the flowchart of FIG. 9 may be performed by the processor 120 of the electronic device 101 or the processor 210 of the electronic device 201.

Referring to FIG. 9, according to an embodiment, when the electronic device 101 is registered in the network (for example, the network 162), the server (for example, the server 106) may transmit PLMN information to the electronic device 101 through the network 162. For example, the network 162 may include a plurality of base stations.

More specifically, the server 106 may receive a request message that makes a request for the PLMN information of the electronic device 101 from a base station connected to the electronic device 101. For example, the request message may include HPLMN information of the electronic device 101. The server 106 may search for at least one preferred roaming PLMN corresponding to an HPLMN of the electronic device 101 in the memory (for example, the memory 305) based on the HPLMN of the electronic device 101. Further, the server 106 may generate PLMN information including at least one found preferred roaming PLMN and transmit the generated PLMN information to the base station.

When the PLMN information is received, the base station may transmit the received PLMN information to the electronic device 101 based on a unique identifier (for example, a phone number) of the electronic device 101 through a message service. For example, the base station may store the unique identifier of the electronic device 101 in advance. For example, the message service may be an SMS which may be transmitted and received through the CS service.

In operation 901, the electronic device 101 (for example, the processor 210) may identify whether the PLMN information is received using the message service through the registered network. When the PLMN information is received based on a result of the identification, the electronic device 101 (for example, the processor 210) may perform operation 903. Otherwise, the electronic device 101 (for example, the processor 210) may repeatedly perform operation 901.

In operation 903, the electronic device 101 (for example, the processor 210) may update the PLMN information. For example, the electronic device 101 (for example, the processor 210) may update the PLMN information stored in the memory 230 based on the received PLMN information. For example, the electronic device 101 (for example, the processor 210) may store at least one preferred roaming PLMN for the local country and the neighboring country in the memory 230.

In operation 905, the electronic device 101 (for example, the processor 210) may identify whether a user-controlled PLMN service is supported. For example, in order to identify whether the user-controlled PLMN list can be updated in the SIM card 224, the electronic device 101 (for example, the processor 210) may identify whether the user-controlled PLMN service is supported.

When the user-controlled PLMN service is supported, the electronic device 101 (for example, the processor 210) may perform operation 907. Otherwise, the electronic device 101 (for example, the processor 210) may end a process of updating the user-controlled PLMN list.

In operation 907, the electronic device 101 (for example, the processor 210) may update the user-controlled PLMN list in the SIM card 224. For example, the electronic device 101 (for example, the processor 210) may update the user-controlled PLMN list based on the received PLMN information.

FIG. 10 is a flowchart illustrating an operation of updating a user-controlled PLMN list according to an embodiment of the present disclosure.

For example, the operation in the flowchart of FIG. 10 may be performed by the electronic device (for example, the electronic device 101 or the electronic device 201). For example, the operation in the flowchart of FIG. 10 may be performed by the processor 120 of the electronic device 101 or the processor 210 of the electronic device 201.

Referring to FIG. 10, in operation 1001, the electronic device 101 (for example, the processor 210) may identify whether the user-controlled PLMN service is supported. For example, in order to identify whether the user-controlled PLMN list can be detected in the SIM card 224, the electronic device 101 (for example, the processor 210) may identify whether the user-controlled PLMN service is supported.

When the user-controlled PLMN service is supported based on a result of the identification, the electronic device 101 (for example, the processor 210) may perform operation 1003. Otherwise, the electronic device 101 (for example, the processor 210) may perform operation 1005.

In operation 1003, the electronic device 101 (for example, the processor 210) may detect a user-controlled PLMN list from the subscriber identification module (for example, the SIM card 224 or the UICC). For example, the user-controlled PLMN list may be updated to include at least one preferred roaming PLMN for the local country and the neighboring country before or after leaving a country. For example, the electronic device 101 (for example, the processor 210) may identify a current location through the GNSS module 227. For example, when the current location is identified as a predetermined location (for example, airport), the electronic device 101 (for example, the processor 210) may update at least one preferred roaming PLMN list. In order to use the user-controlled PLMN list, the electronic device 101 (for example, the processor 210) may detect the user-controlled PLMN list from the SIM card 224 and update the PLMN information stored in the memory 230 based on at least one PLMN included in the detected user-controlled PLMN list.

In operation 1005, the electronic device 101 (for example, the processor 210) may identify whether a PLMN corresponding to a visited country code exists in the detected user-controlled PLMN list. For example, the PLMN may consist of a combination of a mobile country code (MCC) and a mobile network code (MNC).

For example, when being booted, the electronic device 101 (for example, the processor 210) may receive an MCC of a visited country from a neighboring network (for example, the network 162) and compare the MCC of at least one PLMN included in the updated PLMN information and the received MCC, so as to identify whether at least one PLMN corresponding to the received MCC exists in the updated PLMN information.

For example, when the MCC of at least one PLMN is the same as the received MCC, the electronic device 101 (for example, the processor 210) may determine that at least one PLMN corresponding to the received MCC exists in the updated PLMN information. In another example, when the MCC of at least one PLMN is not the same as the received MCC, the electronic device 101 (for example, the processor 210) may determine that at least one PLMN corresponding to the received MCC does not exist in the updated PLMN information.

When at least one PLMN corresponding to the received MCC exists based on a result of the identification, the electronic device 101 (for example, the processor 210) may end a process of updating the PLMN information. Otherwise, the electronic device 101 (for example, the processor 210) may perform operation 1007.

In operation 1007, the electronic device 101 (for example, the processor 210) may identify whether wireless communication is connected. For example, the wireless communication may be wireless communication which does not generate a data communication fee. For example, the wireless communication may be Wi-Fi. For example, the electronic device 101 (for example, the processor 210) may identify whether the electronic device is connected to the Wi-Fi network.

When the wireless communication is connected based on a result of the identification, the electronic device 101 (for example, the processor 210) may perform operation 1009. Otherwise, the electronic device 101 (for example, the processor 210) may perform operation 1011.

In operation 1009, the electronic device 101 (for example, the processor 210) may make a request for PLMN information to the server 106 through wireless communication and receive the PLMN information from the server 106 in response to the request.

According to an embodiment, the electronic device 101 (for example, the processor 210) may transmit a request message that makes the request for the PLMN information to the server 106 through Wi-Fi. For example, the request message may include an HPLMN and a unique identifier (for example, a MAC address or an IP address) of the electronic device 101.

According to an embodiment, when the request message is received, the server 106 may search for at least one preferred roaming PLMN corresponding to an HPLMN of the electronic device 101 in the memory 305 based on the HPLMN of the electronic device 101. Further, the server 106 may generate PLMN information including at least one found preferred roaming PLMN and transmit the generated PLMN information to the electronic device 101 based on a unique identifier of the electronic device 101 through Wi-Fi. For example, the PLMN information may include N preferred roaming PLMNs. In another example, the PLMN information may include 8 preferred roaming PLMNs.

According to an embodiment, the electronic device 101 (for example, the processor 210) may receive the PLMN information from the server 106 through Wi-Fi.

In operation 1011, the electronic device 101 (for example, the processor 210) may make a request for the PLMN information to the server 106 through a message service and receive the PLMN information from the server 106 in response to the request. For example, the message service may be an SMS.

According to an embodiment, the electronic device 101 (for example, the processor 210) may transmit a request message that makes the request for the PLMN information to the server 106 based on the stored unique identifier of the server 106. For example, the request message may include an HPLMN and a unique identifier (for example, a phone number) of the electronic device 101.

According to an embodiment, when the request message is received, the server 106 may search for at least one preferred roaming PLMN corresponding to an HPLMN of the electronic device 101 in the memory 305 based on the HPLMN of the electronic device 101. Further, the server 106 may generate PLMN information including at least one found preferred roaming PLMN and transmit the generated PLMN information to the electronic device 101 based on the unique identifier of the electronic device 101 through the SMS.

According to an embodiment, the electronic device 101 (for example, the processor 210) may receive the PLMN information from the server 106 through the SMS.

In operation 1013, the electronic device 101 (for example, the processor 210) may update the PLMN information. For example, the electronic device 101 (for example, the processor 210) may update the PLMN information stored in the memory 230 based on the received PLMN information. For example, the electronic device 101 (for example, the processor 210) may store at least one preferred roaming PLMN for the local country and the neighboring country in the memory 230.

In operation 1015, the electronic device 101 (for example, the processor 210) may identify whether a user-controlled PLMN service is supported. For example, in order to identify whether the user-controlled PLMN list can be updated in the SIM card 224, the electronic device 101 (for example, the processor 210) may identify whether the user-controlled PLMN service is supported.

When the user-controlled PLMN service is supported, the electronic device 101 (for example, the processor 210) may perform operation 1017. Otherwise, the electronic device 101 (for example, the processor 210) may end a process of updating the user-controlled PLMN list.

In operation 1017, the electronic device 101 (for example, the processor 210) may update the user-controlled PLMN list in the SIM card 224. For example, the electronic device 101 (for example, the processor 210) may update the user-controlled PLMN list based on the received PLMN information.

According to an embodiment, a method of operating an electronic device may include: an operation of registering in an external electronic device through a network having a first PLMN; an operation of acquiring a user-controlled PLMN list related to roaming from a subscriber identification module; and an operation of, when the first PLMN is not included in the user-controlled PLMN list, displaying a message asking whether to use a data service.

According to an embodiment, the user-controlled PLMN list may include a PLMN of at least one service provider who having data roaming contract with a home network service provider related to the electronic device.

According to an embodiment, the operation of acquiring the user-controlled PLMN list may be an operation of updating PLMN information stored in the memory based on at least one PLMN included in the user-controlled PLMN list.

According to an embodiment, the operation of acquiring the user-controlled PLMN list may include: an operation of transmitting a signal for requesting PLMN information related to roaming to another external device through a message service; and an operation of receiving the PLMN information from the network through the message service in response to the request.

According to an embodiment, the method may further include an operation of updating the user-controlled PLMN list based on the received PLMN information.

According to an embodiment, the operation of acquiring the user-controlled PLMN list may include: an operation of transmitting a signal for requesting PLMN information related to the roaming to another external electronic device; an operation of receiving the PLMN information from the other external electronic device in response to the request; and an operation of updating the user-controlled PLMN list based on the received PLMN information.

According to an embodiment, the operation of displaying of the message asking whether to use the data service may include: an operation of, when the first PLMN is not included in the user-controlled PLMN list, displaying a message asking about provision of the data service; and an operation of, when the provision of the data service is selected through the message, providing the data service through the network.

According to an embodiment, the method may further include an operation of, when the provision of the data service is not selected through the message, blocking the provision of the data service through the network.

According to an embodiment, the method may further include an operation of, when the electronic device escapes from an area of the network, registering the electronic device in another network based on a second PLMN; and an operation of, when the second PLMN is included in the user-controlled PLMN list, providing a data service through the other network.

According to an embodiment, the method may further include an operation of, when the second PLMN is not included in the user-controlled PLMN list, displaying a message asking about provision of the data service through the other network.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific integrated circuit (ASIC) chip, a field-programmable gate arrays (FPGA), and a programmable-logic device for performing operations which has been known or are to be developed hereinafter.

According to various embodiments, at least some of the devices (for example, modules or functions thereof) or the method (for example, operations) according to the present disclosure may be implemented by a command stored in a non-transitory computer-readable storage medium in a programming module form. The instruction, when executed by a processor (e.g., the processor 120), may cause the one or more processors to execute the function corresponding to the instruction. The non-transitory computer-readable storage medium may be, for example, the memory 130.

The non-transitory computer readable recoding medium may include a hard disk, a floppy disk, magnetic media (e.g., a magnetic tape), optical media (e.g., a CD-ROM and a DVD), magneto-optical media (e.g., a floptical disk), a hardware device (e.g., a ROM, a RAM, a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

According to an embodiment, an electronic device may include a non-transitory computer-readable recording medium having a program recorded therein to execute operations, the operations including: an operation of registering in an external electronic device through a network having a first PLMN; an operation of acquiring a user-controlled PLMN list related to roaming from a subscriber identification module; and an operation of, when the first PLMN is not included in the user-controlled PLMN list, displaying a message asking whether to use a data service.

According to an embodiment, the user-controlled PLMN list may include a PLMN of at least one service provider having made a data roaming contract with a home network service provider related to the electronic device.

According to an embodiment, the non-transitory computer-readable recording medium may execute an operation of updating PLMN information stored in a memory based on at least one PLMN included in the user-controlled PLMN list.

According to an embodiment, the non-transitory computer-readable recording medium may execute: an operation of transmitting a signal for requesting PLMN information related to roaming to another external device through a message service; and an operation of receiving the PLMN information from the network through the message service in response to the request.

According to an embodiment, the non-transitory computer-readable recording medium may execute: an operation of updating the user-controlled PLMN list based on the received PLMN information.

According to an embodiment, the non-transitory computer-readable recording medium may execute: an operation of transmitting a signal for requesting PLMN information related to the roaming to another external electronic device; an operation of receiving the PLMN information from the other external electronic device in response to the request; and an operation of updating the user-controlled PLMN list based on the received PLMN information.

According to an embodiment, the non-transitory computer-readable recording medium may execute: an operation of, when the first PLMN is not included in the user-controlled PLMN list, displaying a message asking about provision of the data service; and an operation of, when the provision of the data service is selected through the message, providing the data service through the network.

According to an embodiment, the non-transitory computer-readable recording medium may execute an operation of, when the provision of the data service is not selected through the message, blocking the provision of the data service through the network.

According to an embodiment, the non-transitory computer-readable recording medium may execute: an operation of, when the electronic device escapes from an area of the network, registering the electronic device in another network based on a second PLMN; and an operation of, when the second PLMN is included in the user-controlled PLMN list, providing a data service through the other network.

According to an embodiment, the non-transitory computer-readable recording medium may execute an operation of, when the second PLMN is not included in the user-controlled PLMN list, displaying a message asking about provision of the data service through the other network.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

According to various embodiments of the present disclosure, the electronic device can improve user's convenience by providing an apparatus and a method for informing the user of the change of the network when the network is changed.

According to various embodiments of the present disclosure, the electronic device can improve user's convenience by providing an apparatus and a method for automatically registering the electronic device in another network even though the electronic device escapes from the area of the network in which the roaming contract has been made.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a communication circuit;
a memory;
a display;
a subscriber identification module; and
a processor configured to:
register in an external electronic device through a network having a first public land mobile network (PLMN) by using the communication circuit,
acquire a user-controlled PLMN list related to roaming from the subscriber identification module, and
control the display to display a message asking whether to use a data service when the first PLMN is not included in the user-controlled PLMN list.

2. The electronic device of claim 1, wherein the user-controlled PLMN list includes a PLMN of at least one service provider having a data roaming contract with a home network service provider related to the electronic device.

3. The electronic device of claim 1, wherein the processor is configured to update PLMN information stored in the memory based on at least one PLMN included in the user-controlled PLMN list.

4. The electronic device of claim 1, wherein the processor is configured to:
control the communication circuit to transmit a signal for requesting PLMN information related to roaming to another external device through a message service by using the communication circuit, and
receive the PLMN information from the network through the message service in response to the request.

5. The electronic device of claim 4, wherein the processor is configured to update the user-controlled PLMN list based on the received PLMN information.

6. The electronic device of claim 1, further comprising another communication circuit, wherein the processor is configured to:
control the communication circuit to transmit a signal for requesting PLMN information related to the roaming to another external electronic device by using the other communication circuit,
receive the PLMN information from the other external electronic device through the communication circuit in response to the request, and
update the user-controlled PLMN list based on the received PLMN information.

7. The electronic device of claim 1, wherein, when the first PLMN is not included in the user-controlled PLMN list, the processor is configured to control to:
control the display to display a message asking about provision of the data service, and
provide the data service through the network when the provision of the data service is selected through the message.

8. The electronic device of claim 7, wherein, when the provision of the data service is not selected through the message, the processor is configured to block the provision of the data service through the network.

9. The electronic device of claim 1, wherein, when the electronic device leaves an area of the network, the processor is configured to:
register the electronic device in another network based on a second PLMN, and
provide a data service through the other network when the second PLMN is included in the user-controlled PLMN list.

10. The electronic device of claim 9, wherein, when the second PLMN is not included in the user-controlled PLMN list, the processor is configured to control the display to display a message asking about provision of the data service through the other network.

11. A method of operating an electronic device, the method comprising:
registering in an external electronic device through a network having a first public land mobile network (PLMN);
acquiring a user-controlled PLMN list related to roaming from a subscriber identification module; and
when the first PLMN is not included in the user-controlled PLMN list, displaying a message asking whether to use a data service.

12. The method of claim 11, wherein the user-controlled PLMN list includes a PLMN of at least one service provider having a data roaming contract with a home network service provider related to the electronic device.

13. The method of claim 11, wherein the acquiring of the user-controlled PLMN list comprises updating PLMN information stored in the memory based on at least one PLMN included in the user-controlled PLMN list.

14. The method of claim 11, further comprising:
transmitting a signal for requesting PLMN information related to roaming to another external device through a message service; and
receiving the PLMN information from the network through the message service in response to the request.

15. The method of claim 14, further comprising updating the user-controlled PLMN list based on the received PLMN information.

16. The method of claim 11, wherein the acquiring of the user-controlled PLMN list comprises:
transmitting a signal for requesting PLMN information related to the roaming to another external electronic device;
receiving the PLMN information from the other external electronic device in response to the request; and
updating the user-controlled PLMN list based on the received PLMN information.

17. The method of claim 11, wherein the displaying of the message asking whether to use the data service comprises:
when the first PLMN is not included in the user-controlled PLMN list, displaying a message asking about provision of the data service; and
when the provision of the data service is selected through the message, providing the data service through the network.

18. The method of claim 17, further comprising, when the provision of the data service is not selected through the message, blocking the provision of the data service through the network.

19. The method of claim 11, further comprising:
when the electronic device escapes from an area of the network, registering the electronic device in another network based on a second PLMN; and
when the second PLMN is included in the user-controlled PLMN list, providing a data service through the other network.

20. The method of claim 19, further comprising, when the second PLMN is not included in the user-controlled PLMN list, displaying a message asking about provision of the data service through the other network.
